(19) United States
(12) Patent Application Publication
(10) Pub. No.: US 2006/0021105 A1
(43) Pub. Date: Feb. 2, 2006

(54) Ergonomic hand protection apparatus

(76) Inventor: Nick L. Wilson, Middletown, OH (US)

Correspondence Address: GALLAGHER & DAWSEY CO., L.P.A., P.O. BOX 785, COLUMBUS, OH, 43216, US

(21) Appl. No.: 10/902,214

(22) Filed: Jul. 29, 2004

(51) Int. Cl. A41D 13/00; A47J 45/10

(52) U.S. Cl. 2/20

(57) ABSTRACT

An ergonomic hand protection apparatus directed toward protecting the hand, suited for use during loading of a muzzle-loading rifle where the hand is used to force a ramrod into a barrel of a rifle. Since the pressure to properly and safely seat the charge and projectile can be difficult to achieve with the unprotected hand, the instant invention improves safety. The apparatus includes a palm shield that is easily gripped by a cupped hand and a retainer to attach the shield to the wrist so that the shooter can utilize the apparatus with a single hand. One embodiment takes advantage of the anatomy of the hand and incorporates three primary edges; a thenar muscles edge along the thumb side of the palm, a hypothenar muscles edge along the little finger side of the palm, and a distal transverse arch edge along the distal transverse arch edge of the hand.

### TECHNICAL FIELD

The present invention relates to the field of protective body equipment, in particular, to an ergonomic hand protection apparatus.

### BACKGROUND OF THE INVENTION

Humans have long recognized the need to protect certain parts of the human body while performing physically abusive, or risky, tasks. This is particularly true for the hands since they are so important to everyday life and they are body part most commonly put at risk of damage. This is particularly true when loading a muzzle-loading rifle, such as a black powder rifle.

Shooters of muzzle-loading rifles had long appreciated that it is difficult, if not impossible, to grasp a muzzle-loading ramrod by curling the fingers around the ramrod and then push the ramrod into the barrel with enough force to seat the charge of black powder without the fingers simply slipping down the ramrod. Therefore, shooters generally force the ramrod into the barrel by cupping the exterior end of the ramrod in their palm and forcing the ramrod down into the barrel. Such a loading technique is particularly difficult on the hand of the shooter. Further, the hand that most shooters use to force the ramrod into the barrel is most commonly their dominant hand, which is also the hand of their trigger finger. Frequent loading of a muzzle-loading rifle by a dedicated shooter may have adverse long term effects on the nerves, vessels, muscles, bones, and joints of the hand. Additionally, the pressure necessary to properly and safely seat the charge and projectile can be difficult to achieve with the unprotected hand.

Prior art attempts directed to overcoming the risks associated with loading muzzle-loading rifles have been limited and those that exist have distinctive drawbacks. U.S. Pat. No. 6,363,529 ('529) entitled “Finger Glove for Muzzle Loading” issued to Bocook, Jr. is one of the few devices directed to satisfying the needs of muzzle-loading rifle shooters. The '529 device is a pocket-type device, made of nylon strap material, in which the pocket holds the end of a ramrod. The device is worn across several fingers, and allows additional force to be placed on the end of a ramrod. One drawback of the '529 device is that it tends to encourage the application of force to the ramrod that is not entirely parallel with the center of the barrel. For example, since the hand is turned so that the thumb points skyward when the ramrod is in the pocket it is difficult for a user to consistently force the ramrod into the shaft in a parallel fashion. Such variability in loading can lead to the ramrod contacting the interior of the barrel, near the open end, during loading which can mare the interior finish of the barrel and have adverse consequences on the bullet flight characteristics. A more significant drawback is that the '529 device mounts to the fingers and would be rather cumbersome to remove from one's pocket and to install and remove to and from on one's hand while holding a rifle. No matter how nimble a user's fingers, it is unlikely that the '529 device could be installed on user's hand without using both hands. In other words, the user's free hand would have to hold the '529 device and guide it onto the user's fingers during installation, all the while the user is attempting to safely hold the rifle.

The awkward and time consuming installation and removal of the '529 device can be particularly dangerous and traumatic for hunters that use muzzle-loading rifles. For example, if the first shot only maims the game, rather than immediately takes its life, then the hunter wants to reload as quickly as possible to minimize the animal's suffering. When this occurs the hunter's adrenalin is surging and the hunter is full of both excitement and guilt that the initial shot did not humanly take the animals life. In this excited and rushed state a hunter cannot be distracted by having to first find the finger glove, then carefully align fingers with the small loops of the '529 device, and precisely fit the end of the ramrod into the device's pocket.

What has been needed in the muzzle-loading shooting industry is a device that protects the hand by spreading out the force required to force the ramrod in the barrel while being immediately accessible when needed, one that is easy to use so as to only require gripping the device and not requiring any interconnection with the fingers, one that can be positioned to its operable position quickly and with little thought, and one that is reliable and inexpensive. While some prior art methods achieve some of these qualities, none do so in the manner and efficiency of the present invention.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

The ergonomic hand protection apparatus of the present invention is directed toward protecting the ulnar and median nerves, the superficial palmer arch vessel, and the skin and muscles of the hand. The apparatus has particular application to the act of loading a muzzle-loading rifle where the hand is used to repeatedly force a ramrod into a barrel of a rifle. The apparatus includes a palm shield adapted to be easily gripped by a cupped hand and a retainer attached to the shield and adapted to conveniently attach the shield to the wrist, or arm, of the shooter. Additionally, since the pressure necessary to properly and safely seat the charge and projectile can be difficult to achieve with the unprotected hand, the instant invention improves safety in firearm use.

The shield can be virtually any shape; however the overall size must be such that it can be held in place in the palm simply by cupping the hand. When the hand is cupped the natural folds of the skin near the metacarpophalangeal joints and the contour of the hypothenar muscles on the little finger side of the palm and the contour of the thenar muscles on the thumb side of the palm hold the shield securely in place. One particular embodiment takes advantage of the anatomy of the hand and incorporates three primary edges; a thenar muscles edge along the thumb side of the palm, a hypothenar muscles edge along the little finger side of the palm, and a distal transverse arch edge along the distal transverse arch edge of the hand, substantially across the metacarpophalangeal joints. This embodiment yields a substantially triangular shaped shield.

The shield has a thickness, an instrument surface, a palm surface, and a retainer mount. The shield thickness is in part dependent on the material that is used to construct the shield and the construction of the shield itself. The shield may be constructed of virtually any material that can disperse the load applied to the hand by the ramrod as it is forced into the barrel. Generally a relatively resilient material is preferred so that when gripped by a cupped hand the shield may flex to conform to the shape of the palm. The construction of the shield may be as simple as a unitary piece of rubber or plastic, or it may be as complex as a multilayer shield having a rigid insert, such as metal or ceramic, between the layers. Additionally, the thickness may be uniform or variable. Further, the shield may incorporate features that tend to encourage the shield to bend in a certain manner and features that reduce the likelihood that the ramrod slips in the shield during use.

The shield also includes a retainer mount. The retainer mount attaches the shield to the retainer so that the retainer can wrap around the wrist of the shooter. The convenience of having the apparatus always attached near the hand that performs the ramroding is a significant advance over the prior art.

These variations, modifications, alternatives, and alterations of the various preferred embodiments may be used alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 shows a representative ergonomic hand protection apparatus located in an open hand in front elevation view, not to scale;

FIG. 2 shows a representative ergonomic hand protection apparatus located in a cupped hand in front elevation view, not to scale;

FIG. 3 shows a representative ergonomic hand protection apparatus located in an cupped hand in front elevation view as the cupped hand is prepared to force a ramrod into a barrel, not to scale;

FIG. 4 shows a representative ergonomic hand protection apparatus hanging from the wrist of an open hand in front elevation view, not to scale;

FIG. 5 shows a representative ergonomic hand protection apparatus hanging from the wrist of an open hand with a retainer adjuster tightening the retainer around the wrist, not to scale;

FIG. 6 shows a representative ergonomic hand protection apparatus in top plan view, not to scale;

FIG. 7 shows a cross-sectional view of the representative ergonomic hand protection apparatus of FIG. 6 taken along section line 7-7, not to scale;

FIG. 8 shows an alternative cross-sectional view of the representative ergonomic hand protection apparatus of FIG. 7, not to scale;

FIG. 9 shows an alternative cross-sectional view of the representative ergonomic hand protection apparatus of FIG. 7, not to scale;

FIG. 10 shows an alternative cross-sectional view of the representative ergonomic hand protection apparatus of FIG. 7, not to scale;

FIG. 11 shows a representative ergonomic hand protection apparatus in top plan view, not to scale;

FIG. 12 shows a representative ergonomic hand protection apparatus in top plan view, not to scale;

FIG. 13 shows a representative ergonomic hand protection apparatus in top plan view, not to scale;

FIG. 14 shows a representative ergonomic hand protection apparatus in top plan view, not to scale;

FIG. 15 shows a representative ergonomic hand protection apparatus located in an open hand in front elevation view, not to scale;

FIG. 16 shows a representative ergonomic hand protection apparatus located in an open hand in front elevation view, not to scale;

Also, in the various figures and drawings, the following reference symbols and letters are used to identify the various elements described herein below in connection with the several figures and illustrations: B, H, IF, LF, MF, P, R, RF, T, and W.

### DETAILED DESCRIPTION OF THE INVENTION

The ergonomic hand protection apparatus of the instant invention enables a significant advance in the state of the art. The preferred embodiments of the apparatus accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

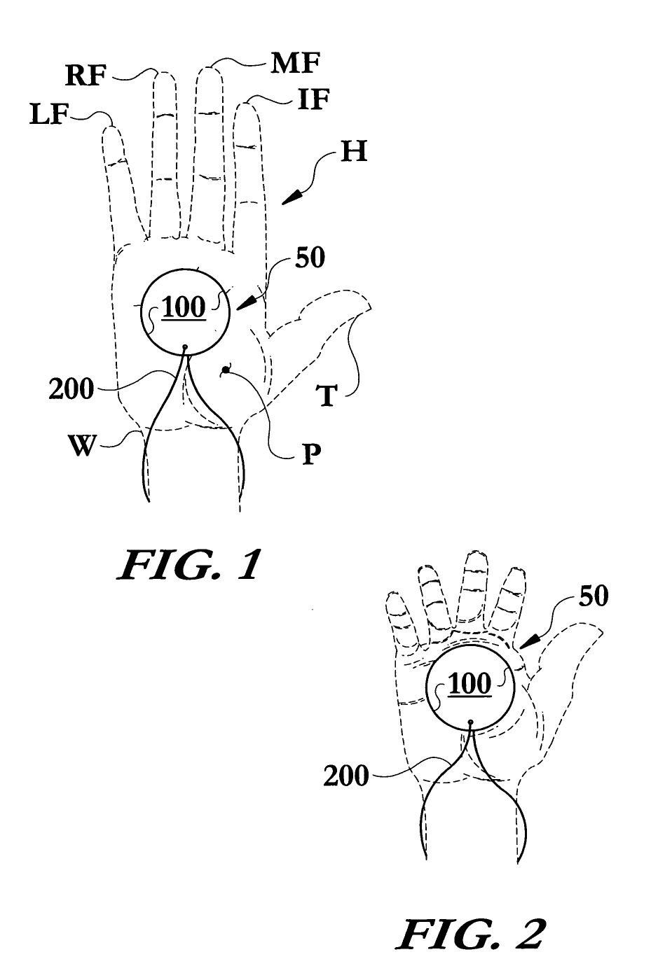

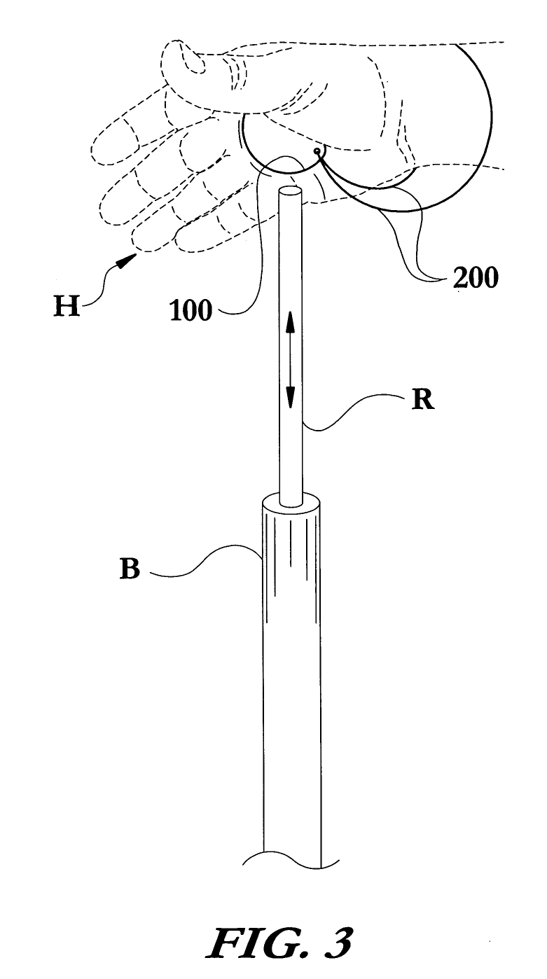

The ergonomic hand protection apparatus 50 of the present invention is directed toward protecting the ulnar and median nerves, the superficial palmer arch vessel, and the skin and muscles of the hand. The apparatus 50 has particular application to the act of loading a muzzle-loading rifle where the hand H is used to repeatedly force a ramrod R into a barrel B, depicted in FIG. 3. The apparatus 50 includes a palm shield 100 adapted to be easily gripped by a cupped hand H and a retainer 200 attached to the shield 100 and adapted to conveniently attach the shield 100 to the wrist W, or arm, of the shooter. The apparatus 50 is shown in an open hand H in FIG. 1 and is shown gripped in a cupped hand H in FIG. 2.

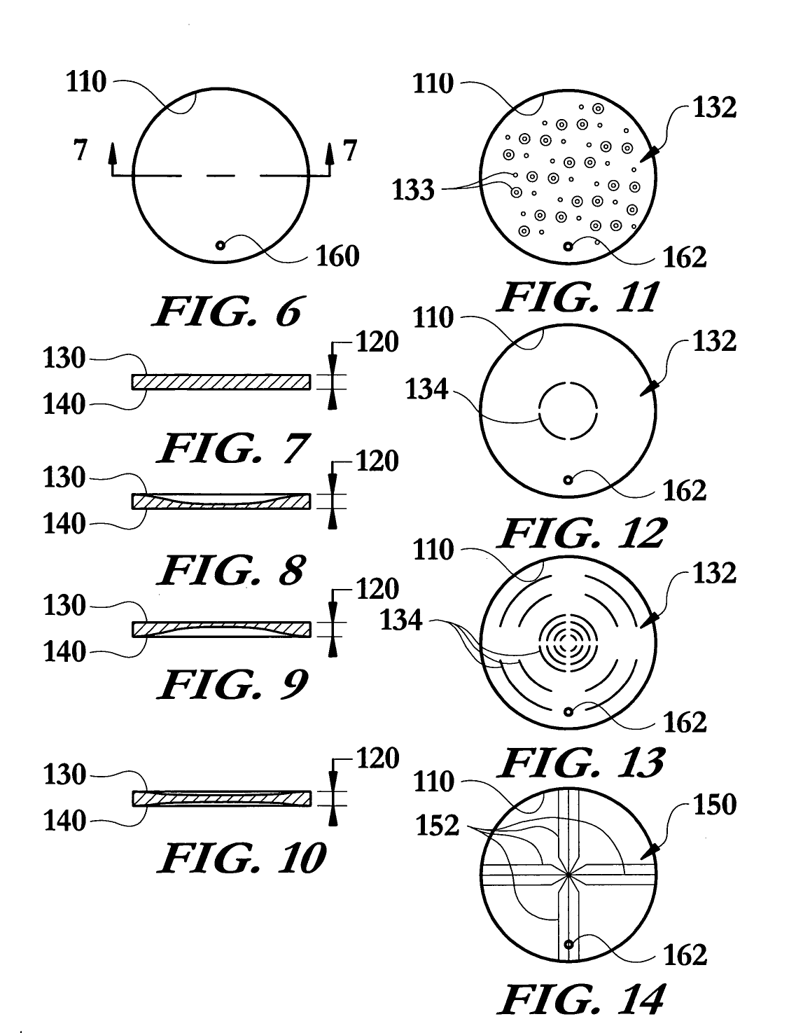

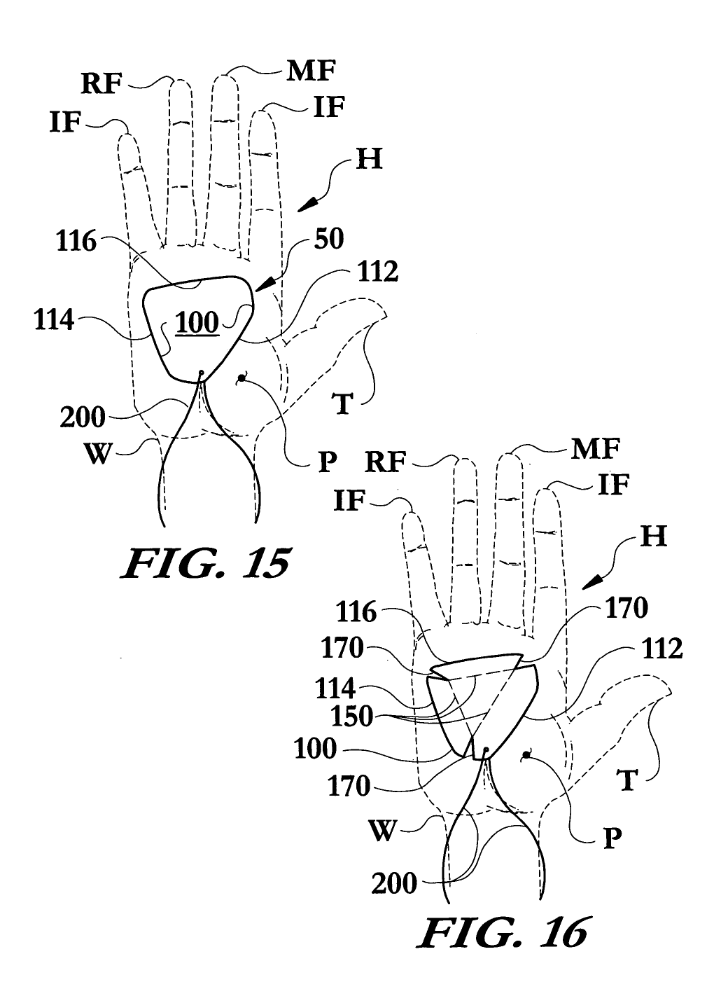

With reference now to FIG. 6, the shield 100 has a periphery 110 that can be virtually any shape. However, the overall size of the shield 100 must be such that it can be held in place in the palm P of a hand H simply by cupping the hand H as shown in FIG. 2. When the hand H is cupped the natural folds of the skin near the metacarpophalangeal joints and the contour of the hypothenar muscles on the little finger LF side of the palm P and the contour of the thenar muscles on the thumb T side of the palm P hold the shield 100 securely in place. The embodiments of FIG. 1 through 14 show the shield 100 as substantially circular in shape, however one with skill in the art can appreciate that other periphery 110 shapes will work equally as well. For instance, the embodiment of FIG. 15 and FIG. 16 incorporate three primary edges in the periphery 110 to take advantage of the anatomy of the hand H. In this embodiment the periphery includes a thenar muscles edge 112 along the thumb T side of the palm P, a hypothenar muscles edge 114 along the little finger LF side of the palm P, and a distal transverse arch edge 116 along the distal transverse arch edge of the hand H, substantially across the metacarpophalangeal joints. The edges 112, 114, 116 are then joined together with smooth radiuses. This embodiment yields a substantially triangular shaped shield 110.

No matter what the shape of the periphery 110, the shield 100 has a thickness 120, an instrument surface 130, a palm surface 140, and a retainer mount 160, as seen in FIG. 6 through FIG. 14. The shield thickness 120 is in part dependent on the material that is used to construct the shield 100. The shield 100 may be constructed of virtually any material that can disperse the load applied to the hand H by the ramrod R as it is forced into the barrel B. Generally a relatively resilient material is preferred so that when gripped by a cupped hand H the shield 100 may flex to conform to the shape of the palm P. The pressure on an unprotected hand H can be extremely high because the force is concentrated at the small surface area of the end of the ramrod R. The shield 100 spreads this load out across a much larger surface area, generally at least five times greater than the surface area of the end of the ramrod R. Additionally, since the pressure necessary to properly and safely seat the charge and projectile can be difficult to achieve with the unprotected hand, the instant invention improves safety in firearm use.

The construction of the shield 100 may be as simple as a unitary piece of rubber or plastic, or it may be as complex as a multilayer shield 100 having a rigid insert, such as metal or ceramic, between the layers. Additionally, the shield 100 may be woven of a high-strength multi-filament polymer yarn such as Kevlar®. In yet another embodiment, a portion of the palm surface 140 may contain a multi-use adhesive to ease gripping of the shield 100. Still further, the shield 100 may be constructed to incorporate carbon based odor control features. For instance, the shield 100 may incorporate activated charcoal to help eliminate the odor associated with sweaty palms that may be detected by game. Additionally, the shield 100 may be constructed to be shock absorbent. In this embodiment the shield 100 would absorb a portion of the shock experienced when the end of the ramrod R encounters the end of the barrel B.

One embodiment of the shield 100 is illustrated in top plan view in FIG. 6. The instrument surface 130 is that surface that is in contact with the ramrod R, whereas the palm surface 140 is that surface in contact with the hand H. Various permissible cross-sections of the shield 100 are shown in FIG. 7 through FIG. 10. For instance, the thickness 120 of the shield 100 may be uniform as seen in FIG. 7. Alternatively, the thickness 120 may be variable to achieve specific predetermined characteristics. The embodiment of FIG. 8 illustrates a concave instrument surface 130. Such an embodiment would help center the end of the ramrod R on the shield 100 and make the shield 100 easier to bend. Conversely, the embodiment of FIG. 9 illustrates a concave palm surface 140. This embodiment results in a shield 100 that is more difficult to bend to contour inward toward the cupped hand H. Still further, the embodiment of FIG. 10 illustrates both a concave instrument surface 130 and a concave palm surface 140. Embodiments that are not illustrated, but can easily be appreciated, are those similar to FIG. 8 through FIG. 10 wherein the instrument surface 130 and the palm surface 140 are convex rather than concave.

Additional embodiments may include at least one bend promoting surface condition 150 to increase the flexibility of the shield 100 in a predetermined manner and permit more reliable gripping and improved contact with the cupped hand H. One such bend promoting surface condition 150 is at least one channel 152 formed in the shield 100 characterized by reduced thickness of the shield 100, as seen in FIG. 14. One can appreciate that the channels 152 need not extend all the way to the center of the shield 100. For example, the channels 152 of FIG. 14 could be applied to the embodiment of FIG. 12 and the channels 152 could terminate at the gripping ridge 134 thereby leaving a nice flat surface within the gripping ridge 134. While the channels 152 may be formed in either the instrument surface 130 or the palm surface 140 they are preferably formed in the palm surface 140 so that the shield 100 may contour to the shape of the palm P when cupped. Additionally, the profile of the channels 152 may be any shape, however a v-profile is preferred when the channels 152 are formed in the instrument face 130.

In addition to the bend promoting surface conditions 150, the shield 100 may be formed with bend promoting recesses 170 to aid in the bending of the shield 100. Three bend promoting recesses 170 are illustrated in FIG. 16. The bend promoting recesses 170 may be either formed in the shield 100 or cut into the shield 100 after manufacture. The bend promoting recesses 170 allow the palm P to more easily grasp and cup the device because the perimeter flaps that are created by the bend promoting recesses 170 easily fold to contour to the cupped hand H leaving a relatively flat center section to receive the end of the ramrod R. Although the bend promoting recesses 170 are shown only with the embodiment of FIG. 16 they may be equally effectively applied to the other embodiments.

In yet a further embodiment, the instrument surface 130 may include at least one area of surface texture 132 to improve the slip-resistance of the instrument surface 130 thereby reducing the likelihood of movement of the ramrod R in the shield 100 as the ramrod R is forced into the barrel B. Any number of surface textures 132 may be incorporated to improve the slip-resistance. For example, in one embodiment the at least one area of surface texture 132 includes a stippling 133 pattern raised above the surface of the instrument surface 130, as seen in FIG. 11. The stippling 133 pattern shown consists of round stipples in a predetermined pattern, however stipples 133 of any shape and pattern may be used. Alternatively, the at least one area of surface texture 132 may include at least one gripping ridge 134, as shown in FIG. 12. The embodiment of FIG. 12 incorporates a single gripping ridge 134 that is sized to receive the end of the ramrod R so that it cannot slip over, or past, the gripping ridge 134 during loading of the riffle. The embodiment of FIG. 13 has a plurality of gripping ridges 134 to increase the coefficient of friction of the instrument surface 130.

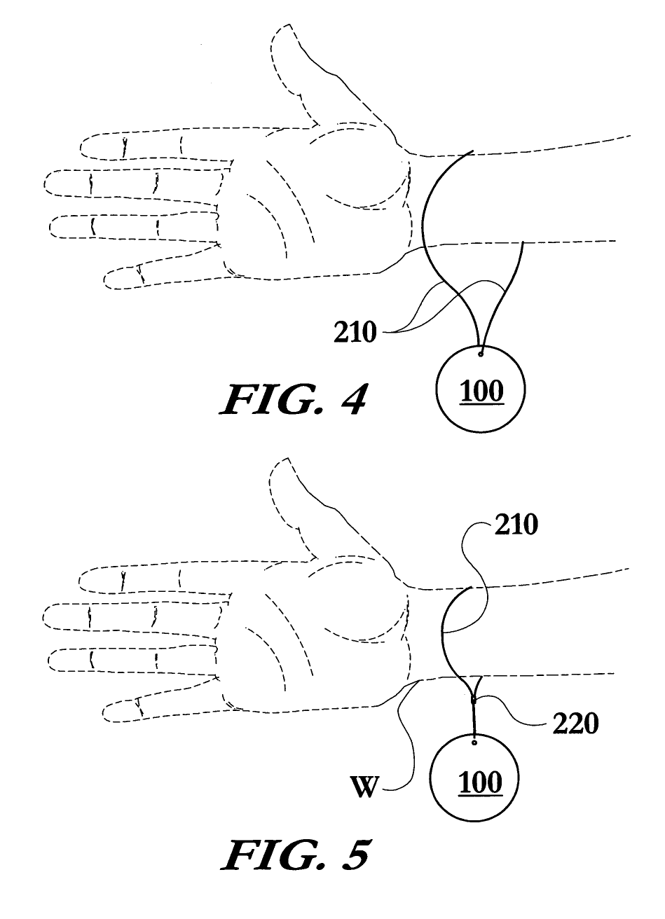

The shield 100 also includes a retainer mount 160. The retainer mount 160 attaches the shield 100 to the retainer 200 so that the retainer 200 can wrap around the wrist W of the user, as seen in FIG. 6. The convenience of having the apparatus 50 always attached near the hand H that performs the ramroding is a significant advance over the prior art. The retainer 200 can be as simple as a strap 210 that is looped through the retainer mount 160 that is formed as a retainer receiver 162, or hole, through the shield 100, as seen in FIG. 11 through FIG. 14. In the embodiments where the retainer 200 is a strap 210 it is generally sized to conveniently slide over the hand H to be worn around the wrist W. The length of the strap 210 is such that it can accommodate a shooter wearing gloves and a thick jacket. Further, the strap 210 may incorporate a retainer adjuster 220, as seen in FIG. 5, so that the strap 210 may be tightened around the wrist W so that is does not accidentally slip off over the hand H. The apparatus 50 is shown hanging from an outstretched horizontal hand H, wrist W, and forearm in FIG. 4. The retainer adjuster 220 is illustrated in FIG. 5 where it has drawn the strap 210 close to the wrist W and forearm so that it cannot slip over the hand H. The design of the apparatus 50 permits a shooter to simply swing the shield 100 up into the palm P of the hand H without the need to use the shooter's other hand H to position the shield 100. As one can appreciate from viewing FIG. 4 and FIG. 5, a simple flick of the forearm and wrist W swings the shield up into the palm P where it is grasped for use.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. An ergonomic hand protection apparatus for protecting the ulnar and median nerves, the superficial palmer arch vessel, and the skin and muscles of a hand, comprising:
a palm shield adapted to be easily gripped by a cupped hand, the shield having a periphery, a thickness, an instrument surface, a palm surface, and a retainer mount, the shield configured to protect the hand as it forces a ramrod into a barrel; and
a retainer attached to the retainer mount and configured to wrap around the wrist.

2. The ergonomic hand protection apparatus of claim 1, wherein the instrument surface has at least one area of surface texture to improve the slip-resistance of the instrument surface thereby reducing the likelihood of movement of the ramrod in the shield as the ramrod is forced into the barrel.

3. The ergonomic hand protection apparatus of claim 2, wherein the at least one area of surface texture includes a stippling pattern raised above the surface of the instrument surface.

4. The ergonomic hand protection apparatus of claim 2, wherein the at least one area of surface texture includes at least one gripping ridge.

5. The ergonomic hand protection apparatus of claim 1, further including at least one bend promoting surface condition to increase the flexibility of the shield in a predetermined manner and permit more reliable gripping and improved contact with the cupped hand.

6. The ergonomic hand protection apparatus of claim 5, wherein the at least one bend promoting surface condition is at least one channel formed in the shield characterized by reduced thickness of the shield.

7. The ergonomic hand protection apparatus of claim 1, wherein the shape of the instrument surface is concave.

8. The ergonomic hand protection apparatus of claim 1, wherein the shape of the palm surface is concave.

9. The ergonomic hand protection apparatus of claim 1, wherein both the instrument surface and the palm surface are concave.

10. The ergonomic hand protection apparatus of claim 1, wherein the periphery includes a thenar muscles edge, a hypothenar muscles edge, and a distal transverse arch edge, the edges being joined together with smooth radiuses.

11. The ergonomic hand protection apparatus of claim 10, further including at least one bend promoting recess to increase the flexibility of the shield in a predetermined manner and permit more reliable gripping and improved contact with the cupped hand.

12. The ergonomic hand protection apparatus of claim 1, wherein the retainer mount is a retainer recess in the shield and the retainer is a strap, the retainer recess configured so that the strap may pass through the retainer recess.

13. The ergonomic hand protection apparatus of claim 12, further including a retainer adjuster slidably mounted to the strap so that the strap may be tightened around the wrist to prevent the apparatus from inadvertently sliding off the hand.

14. The ergonomic hand protection apparatus of claim 1, wherein the shield is constructed of a resilient material.

15. The ergonomic hand protection apparatus of claim 14, wherein the resilient material woven of a high-strength multi-filament polymer yarn.

16. The ergonomic hand protection apparatus of claim 1, wherein a portion of the palm surface contains a multi-use adhesive.

17. An ergonomic hand protection apparatus for protecting the ulnar and median nerves, the superficial palmer arch vessel, and the skin and muscles of a hand, comprising:
a palm shield adapted to be easily gripped by a cupped hand, the shield having a periphery, a thickness, an instrument surface, a palm surface, and a retainer mount, the shield configured to protect the hand as it forces a ramrod into a barrel;
at least one area of surface texture on the instrument surface to improve the slip-resistance of the instrument surface thereby reducing the likelihood of movement of the ramrod in the shield as the ramrod is forced into the barrel;
at least one bend promoting surface condition to increase the flexibility of the shield in a predetermined manner and permit more reliable gripping and improved contact with the cupped hand; and
a retainer attached to the retainer mount and configured to wrap around the wrist.

18. The ergonomic hand protection apparatus of claim 17, wherein the at least one area of surface texture includes a stippling pattern raised above the surface of the instrument surface.

19. The ergonomic hand protection apparatus of claim 18, wherein the at least one area of surface texture includes at least one gripping ridge.

20. The ergonomic hand protection apparatus of claim 17, wherein the at least one bend promoting surface condition is at least one channel formed in the shield characterized by reduced thickness of the shield.

21. The ergonomic hand protection apparatus of claim 17, wherein the shape of the instrument surface is concave.

22. The ergonomic hand protection apparatus of claim 17, wherein the shape of the palm surface is concave.

23. The ergonomic hand protection apparatus of claim 17, wherein both the instrument surface and the palm surface are concave.

24. The ergonomic hand protection apparatus of claim 17, wherein the periphery includes a thenar muscles edge, a hypothenar muscles edge, and a distal transverse arch edge, the edges being joined together with smooth radiuses.

25. The ergonomic hand protection apparatus of claim 24, further including at least one bend promoting recess to increase the flexibility of the shield in a predetermined manner and permit more reliable gripping and improved contact with the cupped hand.

26. The ergonomic hand protection apparatus of claim 17, wherein the retainer mount is a retainer recess in the shield and the retainer is a strap, the retainer recess configured so that the strap may pass through the retainer recess.

27. The ergonomic hand protection apparatus of claim 26, further including a retainer adjuster slidably mounted to the strap so that the strap may be tightened around the wrist to prevent the apparatus from inadvertently sliding off the hand.

28. An ergonomic hand protection apparatus for protecting the ulnar and median nerves, the superficial palmer arch vessel, and the skin and muscles of a hand, comprising:
a palm shield adapted to be easily gripped by a cupped hand, the shield having a periphery, a thickness, an instrument surface, a palm surface, and a retainer recess, wherein the wherein the periphery includes a thenar muscles edge, a hypothenar muscles edge, and a distal transverse arch edge, the edges being joined together with smooth radiuses, wherein the shield is configured to protect the hand as it forces a ramrod into a barrel;
at least one area of surface texture, including at least one gripping ridge, on the instrument surface to improve the slip-resistance of the instrument surface thereby reducing the likelihood of movement of the ramrod in the shield as the ramrod is forced into the barrel;
at least one bend promoting surface condition consisting of at least one channel formed in the shield characterized by reduced thickness of the shield and at least one bend promoting recess to increase the flexibility of the shield in a predetermined manner and permit more reliable gripping and improved contact with the cupped hand;
a strap configured to pass through the retainer recess and configured to wrap around the wrist; and
a retainer adjuster slidably mounted to the strap so that the strap may be tightened around the wrist to prevent the apparatus from inadvertently sliding off the hand.
